(19) United States
(12) Patent Application Publication
(10) Pub. No.: US 2001/0054137 A1
(43) Pub. Date: Dec. 20, 2001

(54) CIRCUIT ARRANGEMENT AND METHOD WITH IMPROVED BRANCH PREFETCHING FOR SHORT BRANCH INSTRUCTIONS

(76) Inventors: RICHARD JAMES EICKEMEYER, ROCHESTER, MN (US); PHILIP ROGERS HILLIER III, ROCHESTER, MN (US)

Correspondence Address: SCOTT A STINEBRUNER, WOOD HERRON & EVANS, 2700 CAREW TOWER, 441 VINE STREET, CINCINNATI, OH, 452022917

(21) Appl. No.: 09/095,295

(22) Filed: Jun. 10, 1998

(51) Int. Cl. G06F 15/00; G06F 9/00

(52) U.S. Cl. 712/11; 712/233

(57) ABSTRACT

A data processing system, circuit arrangement, integrated circuit device, program product, and method selectively prefetch a non-cached target memory address for a branch instruction when the target memory address is in a predetermined portion of a memory address space, e.g., within a predetermined number of cache lines from a branch instruction being processed. By prefetching the non-cached target memory addresses for this subclass of branch instructions, the delays associated with retrieving the target memory addresses from higher order memory are minimized. Moreover, by limiting such prefetching to only this subclass of branch instructions, the frequency of retrieval of unneeded data into the cache is often reduced.

### FIELD OF THE INVENTION

The invention is generally related to integrated circuit device architecture and design, and in particular to instruction buffer branch prefetching in an integrated circuit device.

### BACKGROUND OF THE INVENTION

Computer technology continues to advance at a remarkable pace, with numerous improvements being made to the performance of both microprocessors —the “brains” of a computer—and the memory that stores the information processed by a computer.

In general, a microprocessor operates by executing a sequence of instructions that form a computer program. The instructions are typically stored in a memory having a plurality of storage locations identified by unique memory addresses. The memory addresses collectively define a “memory address space,” representing the addressable range of memory addresses that can be accessed by a microprocessor.

When executing a computer program, a microprocessor must “fetch” the instructions from memory before the instructions can be executed. However, the speed of microprocessors has increased relative to that of memory to the extent that retrieving instructions from a memory can often become a significant bottleneck on the performance of many computers. In particular, both memory speed and memory capacity are directly related to cost, and as a result, many computer systems rely on multiple levels of memory devices to balance speed, capacity and cost. Often, a computer relies on a relatively large, slow and inexpensive mass storage system such as a hard disk drive or other external storage device, an intermediate main memory that uses dynamic random access memory devices (DRAM's) or other volatile memory storage devices, and one or more high speed, limited capacity cache memories, or caches, implemented with static random access memory devices (SRAM's) or the like.

Many conventional microprocessors use dedicated instruction units that dispatch instructions to be processed to one or more execution units in the microprocessors. A conventional instruction unit typically “prefetches” instructions to be processed into an instruction buffer, and then dispatches those instructions in sequence to appropriate execution units. As long as an instruction unit maintains a supply of prefetched instructions in the instruction buffer, a constant stream of instructions may be dispatched, which maximizes the utilization of the execution units and often ensures optimal performance in the microprocessor.

Therefore, to maximize performance, whenever possible a microprocessor typically fetches instructions that are stored in the lowest level and fastest level of memory—often an integrated cache known as an instruction cache—to minimize the time required to access the instructions. However, whenever a microprocessor attempts to access instructions that are not presently stored in the instruction cache, a “cache miss” occurs, necessitating that the instructions be retrieved from a higher level of memory, e.g., a higher level cache, main memory or external storage. During retrieval of the instructions, often known as a “cache fill,” the instruction buffer may be emptied and may remain so until the instructions are retrieved. During this time, the execution units have no instructions to process, and the microprocessor in essence must wait for retrieval of the instructions, thereby reducing the overall performance of the computer.

A cache fill operation typically results in the retrieval of a “cache line” from lower level memory. Specifically, to facilitate the operation of a cache, a memory address space is typically partitioned into a plurality of cache lines, which are typically contiguous sequences of memory addresses that are always swapped into and out of a cache as single blocks. By organizing memory addresses into defined cache lines, decoding of memory addresses in a cache is significantly simplified, thereby significantly improving cache performance. Stating that a block of memory addresses forms a cache line, however, does not imply that the block is presently stored in a cache. Rather, the implication is that if the data from any address from the block of memory addresses is stored in the cache, the data from the other memory addresses from the block is as well.

One specific type of instruction that is often handled separately by a microprocessor is a branch instruction. A branch instruction refers to a target memory address that indicates where the next instruction to execute after the branch instruction can be found. A specific type of branch instruction is a conditional branch instruction, which only passes control to an instruction specified by a target memory address whenever a specific condition is met, e.g., go to instruction x only if y=0. Otherwise, if the condition is not met, the instruction immediately following the branch instruction is executed. Often, the different sequences of instructions that may be executed in response to a conditional branch instruction are referred to as “paths.”

To speed the execution of branch instructions, a process known as branch prefetching is often used. One type of branch prefetching, for example, uses prediction logic such as a directory to attempt to predict the path that will likely be taken by a branch instruction. Based upon this prediction, the instruction unit fetches either the instruction after the branch instruction or the instruction specified by the target memory address for the branch instruction prior to determining whether the condition is actually met—a process known as “resolving” the branch instruction.

Another type of branch prefetching, on the other hand, does not attempt to predict the likely path. Rather, with this non-predictive type of branch prefetching, both paths are fetched, with the path represented by the target memory address stored in a separate branch buffer. Then, when the branch instruction is resolved, the instructions from the correct buffer can be dispatched immediately to the execution units for processing.

A problem arises, however, when the path represented by the target memory address is non-cached—i.e., is not presently stored in the instruction cache—since an attempt to fetch the instruction results in a cache miss and requires the cache line for the target memory address to be retrieved from higher level memory. Branch instructions are encountered rather frequently in a computer program, and a large portion of these branches are not actually taken. As a result, performing cache fill operations for each and every branch instruction to a non-cached cache line often overloads the instruction cache and needlessly delays the retrieval of instructions that are actually known to be needed.

For this reason, a number of conventional non-predictive branch prefetching designs do not prefetch a branch path of a branch operation if doing so would result in a cache miss. By not prefetching such branch paths, however, the cache fill operation that must ultimately be performed if a branch that is in fact taken is delayed until after the branch instruction is resolved.

Another manner of dealing with the problem of cache misses is to always perform a cache fill for the next sequential cache line following the cache line for the instructions currently being processed. However, similar to fetching the target memory address for each and every branch instruction regardless of the cached status thereof, performing a cache fill for the next sequential cache line in every instance would likely result in filling the instruction cache with a significant amount of unneeded data and otherwise slow the operation of the instruction cache. A variation of this approach is to wait until nearing the end of a cache line before requesting a cache fill of the next sequential cache line; however, only limited performance gains are typically achieved since some delay is still associated with retrieving the data from the next sequential cache line at such a late stage of processing instructions from a current cache line.

Therefore, a significant need exists for an improved manner of prefetching the branch paths of branch instructions. Specifically, a need exists for a manner of prefetching the branch paths of branch instructions that reduces the delays associated with cache misses without overloading an instruction cache with frequent unnecessary cache fill operations.

### SUMMARY OF THE INVENTION

The invention addresses these and other problems associated with the prior art by providing a data processing system, circuit arrangement, integrated circuit device, program product, and method that selectively prefetch a non-cached target memory address for a branch instruction when the target memory address is in a predetermined portion of a memory address space. By prefetching the non-cached target memory addresses for this subclass of branch instructions, the delays associated with retrieving the target memory addresses from higher order memory are minimized. Moreover, by limiting such prefetching to only this subclass of branch instructions, the frequency of retrieval of unneeded data into the cache is often reduced.

In certain embodiments of the invention, for example, the predetermined portion of the memory address space is a range of memory addresses within a predetermined distance, e.g., within a predetermined number of cache lines, from a branch instruction being processed. In this regard, the subclass of branch instructions may be referred to in such embodiments as “short branch” instructions. It is believed that a large segment of branch instructions are of this type, and thus, a greater likelihood exists that retrieving the target memory addresses therefor will not go to waste. Moreover, one additional benefit of this approach is that, even if a short branch instruction is not taken, prefetching the cache line for the target memory address therefor often improves performance because a strong likelihood often exists that processing may still proceed sequentially from the non-taken short branch instruction into the cache line for the target memory address.

Consistent with the invention, a method of processing instructions is provided. The method includes fetching a first instruction from a first memory address in a memory address space; determining whether the first instruction includes a branch to a target memory address in a predetermined portion of the memory address space; and, if the target memory address is in the predetermined portion of the memory address space, fetching a target instruction from the target memory address.

Consistent with an additional aspect of the invention, a method of processing instructions is provided, including fetching a branch instruction from a first memory address in a memory address space; and fetching a target memory address for the branch instruction prior to determining whether the branch instruction will be taken if the target memory address is cached or if the target memory address is within a predetermined distance from the first memory address.

Consistent with another aspect of the invention, a circuit arrangement is provided. The circuit arrangement includes a cache configured to store a plurality of instructions that are addressed at selected memory addresses in a memory address space; and an instruction unit coupled to the cache. The instruction unit is configured to dispatch selected instructions from the cache to an execution unit for execution thereby, and to fetch a target instruction referenced by a branch instruction prior to determining whether a branch therefor will be taken, and regardless of whether the target instruction is stored in the cache, if the target instruction is addressed at a target memory address within a predetermined portion of the memory address space.

Consistent with yet another aspect of the invention, a data processing system is provided, which includes a memory defining a memory address space and including a plurality of memory addresses; and an integrated circuit device coupled to the memory. The integrated circuit device includes a cache coupled to the memory and configured to store a plurality of instructions that are addressed at selected memory addresses in the memory address space; and an instruction unit coupled to the cache. The instruction unit is configured to dispatch selected instructions from the cache to an execution unit for execution thereby, and to fetch a target instruction referenced by a branch instruction prior to determining whether a branch therefor will be taken, regardless of whether the target instruction is stored in the cache, and if the target instruction is addressed at a target memory address within a predetermined portion of the memory address space.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described exemplary embodiments of the invention.

### BRIEF DESCRIPTION OF THE DRAWINGS

FIG. 1 is a block diagram of a data processing system consistent with the invention.

FIG. 2 is a block diagram of a circuit arrangement for the system processor in the data processing system of FIG. 1.

FIG. 3 is a flowchart illustrating the program flow of the branch prefetch logic block of FIG. 2.

FIG. 4 is a block diagram of a circuit arrangement for use in detecting a short branch with the branch prefetch logic block of FIG. 2.

FIG. 5 is a block diagram illustrating an exemplary sequence of instructions to be processed by the system processor of FIG. 2.

FIG. 6 is a timing diagram illustrating the timing of operations in the system processor of FIG. 1 in response to taking a short conditional branch in the exemplary sequence of instructions of FIG. 5.

FIG. 7 is a timing diagram illustrating the comparative timing of operations in a conventional processor in response to taking a short conditional branch in the exemplary sequence of instructions of FIG. 5.

FIG. 8 is a timing diagram illustrating the timing of operations in the system processor of FIG. I in response to not taking a short conditional branch in the exemplary sequence of instructions of FIG. 5.

FIG. 9 is a timing diagram illustrating the comparative timing of operations in a conventional processor in response to not taking a short conditional branch in the exemplary sequence of instructions of FIG. 5.

### DETAILED DESCRIPTION

The illustrated implementations of the invention generally operate by detecting the presence of a short branch and prefetching, prior to actual resolution of the branch, the target memory address therefor regardless of whether the target memory address is presently stored in a cache such as an instruction cache. This has the advantage that, if the short branch is ultimately taken, the time delay associated with filling the instruction cache with the cache line of the target memory address during fetching is reduced. Moreover, when the short branch is into the next sequential cache line, even if the short branch is ultimately not taken and processing occurs sequentially into the next cache line, any time delay that would be required to fill the instruction cache with the next sequential cache line is also reduced.

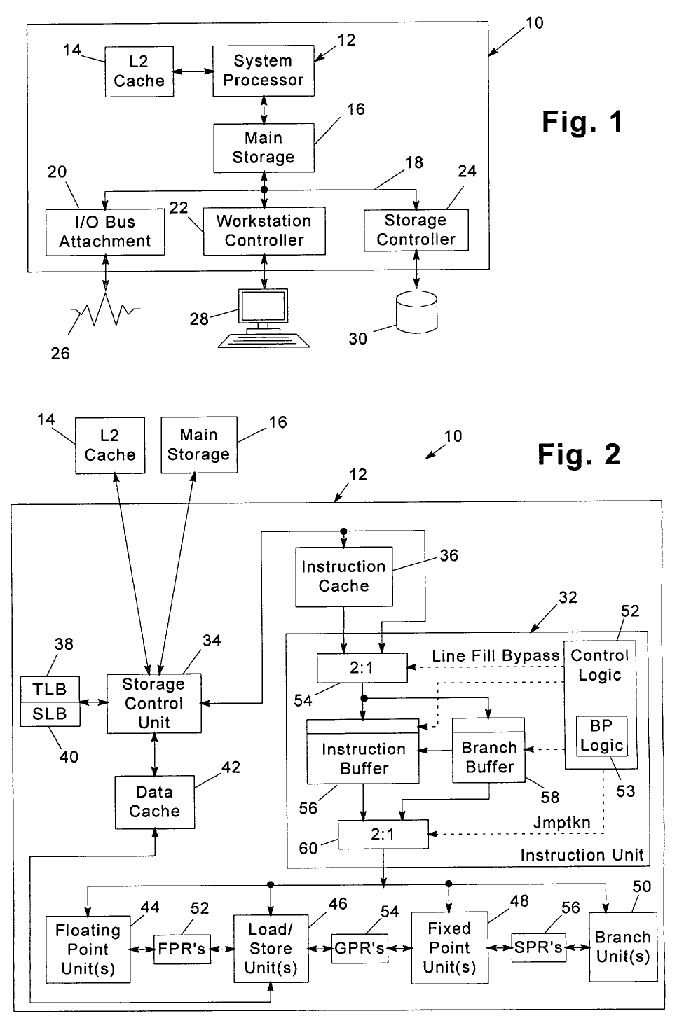

Turning to the Drawings, wherein like numbers denote like parts throughout the several views, FIG. 1 illustrates the general configuration of an exemplary data processing system 10 suitable for implementation of instruction prefetching consistent with the invention. System 10 generically represents, for example, any of a number of multi-user computer systems such as a network server, a midrange computer, a mainframe computer, etc. However, it should be appreciated that the invention may be implemented in other data processing systems, e.g., in stand-alone or single-user computer systems such as workstations, desktop computers, portable computers, and the like, or in other computing devices such as embedded controllers and the like. One suitable implementation of data processing system 10 is in a midrange computer such as the AS/400 computer available from International Business Machines Corporation.

Data processing system 10 generally includes one or more system processors 12 coupled to one or more storage devices, e.g., a level two (L2) cache 14 and a main storage unit 16, among others. The data processing system 10 typically includes an addressable memory address space including a plurality of memory addresses. The actual data stored at such memory addresses may be maintained in main storage unit 16, or may be selectively paged in and out of main storage unit 16. Moreover, copies of selective portions of the memory addresses in the memory space may also be duplicated in L2 cache 14 and/or various caches in system processor 12 (as discussed below) to decrease the latency associated with reading data from and writing data to such memory addresses.

For caching purposes, the memory address space is typically also partitioned into a plurality of cache “lines”, which are typically contiguous sequences of memory addresses that are always swapped into and out of a cache as single units. By organizing memory addresses into defined cache lines, decoding of memory addresses in a cache is significantly simplified, thereby significantly improving cache performance. By stating that a sequence of memory addresses forms a cache line, however, no implication is made whether the sequence of memory addresses are actually cached at any given time.

The processor/memory subsystem represented by components 12-16 is also coupled via one or more interface buses, e.g., bus 18, to one or more input/output devices, e.g., an I/O bus attachment interface 20, a workstation controller 22 and a storage controller 24, among others. Interface 20 may be coupled to an external network or other interface 26 to provide an extension of bus 18 to support additional input/output devices. Workstation controller 22 is coupled to one or more workstations 28 to support multiple users, and storage controller 24 is coupled to one or more external devices 30 to provide additional storage for data processing system 10. It should be appreciated, however, that data processing system 10 is merely representative of one suitable environment for use with the invention, and that the invention may be utilized in a multitude of other environments in the alternative.

Instruction prefetching consistent with the invention is typically implemented in a circuit arrangement on a system processor or other programmable integrated circuit device, and it should be appreciated that a wide variety of programmable devices may utilize instruction prefetching consistent with the invention. Moreover, as is well known in the art, integrated circuit devices are typically designed and fabricated using one or more computer data files, referred to herein as hardware definition programs, that define the layout of the circuit arrangements on the devices. The programs are typically generated by a design tool and are subsequently used during manufacturing to create the layout masks that define the circuit arrangements applied to a semiconductor wafer. Typically, the programs are provided in a predefined format using a hardware definition language (HDL) such as VHDL, verilog, EDIF, etc. While the invention has and hereinafter will be described in the context of circuit arrangements implemented in fully functioning integrated circuit devices and data processing systems utilizing such devices, those skilled in the art will appreciate that circuit arrangements consistent with the invention are capable of being distributed as program products in a variety of forms, and that the invention applies equally regardless of the particular type of signal bearing media used to actually carry out the distribution. Examples of signal bearing media include but are not limited to recordable type media such as volatile and non-volatile memory devices, floppy disks, hard disk drives, CD-ROM's, and DVD's, among others and transmission type media such as digital and analog communications links.

One representative architecture for system processor 12 of data processing system 10, which implements a circuit arrangement consistent with the invention, is illustrated in greater detail in FIG. 2. System processor 12, for example, includes one or more instruction units 32 coupled to receive instructions to be processed from a storage control unit 34 and an instruction cache 36. The storage control unit 34 is typically interfaced with a higher level cache such as L2 cache 14, as well as main storage unit 16. Moreover, storage control unit 34 relies on a translation lookaside buffer (TLB) 38 and a segment lookaside buffer (SLB) 40 for use in handling data exchange between L2 cache 14, main storage 16, instruction cache 36 and a data cache 42 (also known as a level 1, or L1 cache).

Instruction unit 32 is also interfaced with a number of execution units, e.g., one or more floating point units (FPU's) 44, one or more load/store units 46, one or more fixed point units 48 and/or one or more branch units 50. Each execution unit may support one or more registers, e.g., floating point registers (FPR's) 52, general purpose registers (GPR's) 54, and/or special purpose registers (SPR's) 56. Moreover, each load/store unit 46 is typically interfaced with data cache 42 to perform data transfers to and from the various registers coupled thereto.

It should be appreciated that the general architecture illustrated herein is representative of a number of conventional microprocessor architectures, e.g., the PowerPC RISC architecture utilized in the system processors on the AS/400 midrange computer system, among others, and thus, the design and operation of the principal components in this architecture will be apparent to one of ordinary skill in the art. Morever, it should further be appreciated that the invention may be utilized in a multitude of other processor architectures in the alternative, or with other memory architectures (e.g., with different arrangements of caches) and thus, the invention should not be limited to the specific architecture described herein.

Instruction unit 32 is used to fetch and dispatch instructions to execution units 44, 46, 48 and/or 50. Instruction unit 32 is under the control of a control logic block 52 that provides control signals to a line fill bypass multiplexer 54, an instruction buffer 56, a branch buffer 58 and a branch select multiplexer 60.

Line fill bypass multiplexer 54 is utilized to bypass instruction cache 36 in response to assertion of a Line Fill Bypass signal from control logic block 52 so that instructions being fetched into the instruction cache may simultaneously be forwarded directly to the instruction unit.

Instruction buffer 56 stores the primary sequence of instructions being processed by the instruction unit, and branch buffer 58 stores instructions located at the target addresses specified by one or more branch instructions stored in the instruction buffer, so that, once it is determined that such a branch should be taken, processing of the instructions stored at the target addresses may be immediately executed without having to separately fetch those instructions.

Instruction buffer 56 and branch buffer 58 each output to branch select multiplexer 60, which outputs an instruction from either block based upon whether a branch instruction being processed is actually taken. Control logic block 52 makes such a determination and selectively asserts a Jmptkn signal whenever it is determined that a branch should be taken so that the instructions at the target address of the branch can be output from the branch buffer and executed by the appropriate execution unit.

Control logic block 52 includes one or more logic sequencers, including a branch prefetch logic block 53 that is used to analyze instructions in the instruction buffer to locate any branches and then prefetch into branch buffer 58 any instructions that would be executed were such branches taken. Other sequencers, e.g., sequential prefetch and dispatch sequencers, among others, may also be utilized in control logic block 52. The design and operation of such other sequencers, however, will be readily apparent to one of ordinary skill in the art.

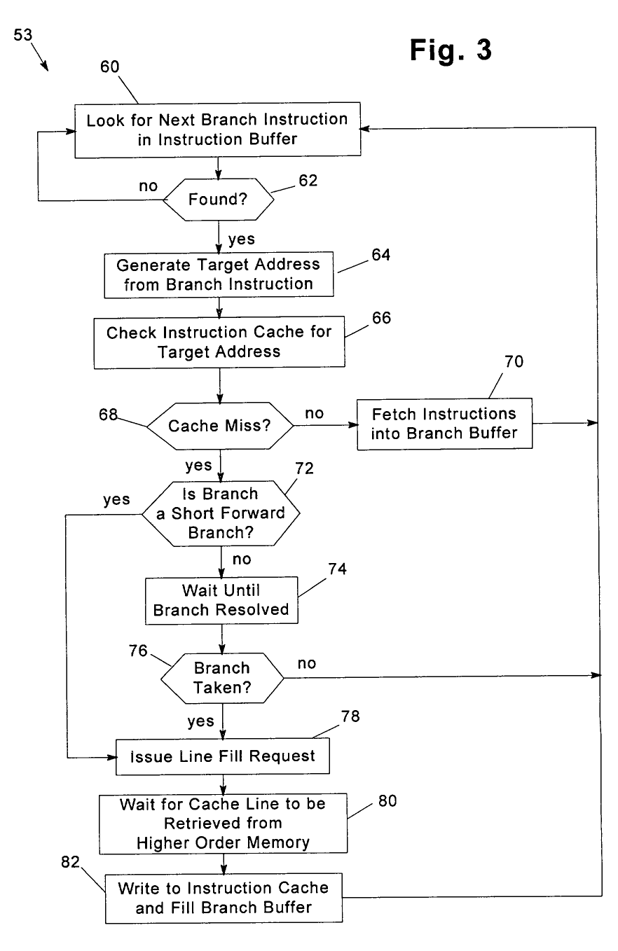

The program flow of branch prefetch logic block 53 is illustrated in greater detail in FIG. 3, and, with the exception of the differences noted below, principally operates in substantially the same manner as a number of conventional branch prefetching algorithms that attempt to prefetch both potential paths for a conditional branch. Branch prefetching generally operates via a continuous loop starting at block 60, where the next branch instruction in the instruction buffer (if any) is located. Typically, only a subset of the instruction buffer is analyzed, e.g., the first six instructions in the buffer, and the next branch instruction is the first such instruction found in the instruction buffer.

Next, in block 62 it is determined whether a branch instruction has been found. If not, control passes back to block 60 to search again for a branch instruction in the instruction buffer. It should be appreciated that, by virtue of the operation of other sequencers in control logic block 52, instructions will be dispatched from, and new instructions will be fetched into, the instruction buffer concurrently with the operation of prefetch logic block 53.

If a branch instruction is found, however, control passes to block 64 to generate the target address from the branch instruction, in a manner well known in the art, and which will vary depending upon the type of branch (e.g., relative, absolute, indirect, etc.) and the instruction set for the processor, among other factors. Next, control passes to block 66 to check instruction cache 36 to determine whether the instruction stored at the target address is in the instruction cache. If so (i.e., when there is a “cache hit”), block 68 passes control to block 70 to fetch the instruction stored at the target address, as well as a predetermined number of instructions thereafter, into branch buffer 58, whereby control may then return to block 60 to locate the next branch instruction in the instruction buffer.

If, however, the instruction stored at the target address is not in the instruction cache (i.e., when there is a “cache miss”), block 68 passes control to block 72 to determine whether the branch is a short branch—that is, whether the branch is a conditional branch to a predetermined portion of the memory address space (discussed below).

First, assuming the branch is not a short branch, a program flow similar to conventional branch prefetching algorithms is utilized. Specifically, control passes to block 74 to wait until the branch is resolved (i.e., until it is determined whether or not the branch should be taken). If it is determined that the branch should not be taken, block 76 passes control back to block 60 to locate the next branch instruction in the instruction buffer.

If the branch should be taken, however, block 76 passes control to block 78 to issue a line fill request to fetch the cache line within which is stored the next instruction to be processed. Next, block 80 waits until the requested cache line is retrieved from higher order memory (from either the L2 cache, the main storage unit, or an external storage device), and once this cache line is retrieved, block 82 writes the line into the instruction cache and simultaneously fills the branch buffer via asserting the Line Fill Bypass signal to line fill bypass multiplexer 54. Control then returns to block 60 to process the next sequential instruction.

It should be appreciated that typically a separate sequencer will handle transfers of instructions from the branch buffer to the instruction buffer on an as-needed basis. Thus, typically as a result of resolution of a branch, the separate sequencer flushes the branch buffer if the branch is not taken. If the branch is taken, however, the appropriate instructions in the branch buffer are moved into the instruction buffer. The configuration and operation of a sequencer that performs this functionality are well within the abilities of one of ordinary skill in the art.

Now returning to block 72, a short branch is detected whenever the instruction being processed is a conditional branch to a predetermined portion of the memory address space. Generally, the predetermined portion of the memory address space can be any area of memory (typically relative to the memory address of the branch instruction) where for performance reasons prefetching of the target memory address for the branch instruction is desirable regardless of whether the target memory address is currently cached in the instruction cache. Typically, this condition occurs whenever the target memory address is located within a predetermined number of cache lines from the cache line within which the branch instruction is stored.

The number of cache lines to use in the determination of a short branch typically depends upon a number of factors, including the operating system, the application software, the instruction size, the cache line size, and/or the instruction set architecture, among other factors. In the illustrated implementation, with 32-bit instructions and 128-byte cache lines, a short branch is defined to be a branch that has a target memory address that is within the current or next sequential cache line. However, other short branch definitions may be utilized in other implementations consistent with the invention.

Thus, whenever the branch instruction being processed is determined to be a short branch, block 72 passes control directly to block 80 to issue a line fill request for the cache line containing the target memory address, which in this case, is the next sequential cache line to that for the current branch instruction (since if the target memory address was in the same cache line as the branch instruction, no cache miss would be detected). As a result, the cache line retrieval is initiated prior to resolution of the branch instruction.

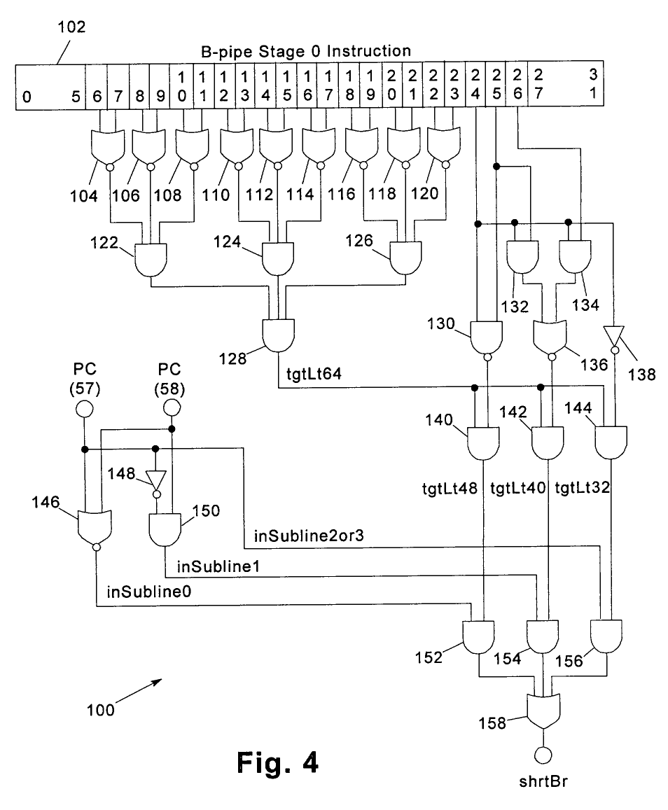

Determination of whether a branch is a short branch may be performed in a number of manners. For example, FIG. 4 illustrates one suitable short branch detection logic circuit arrangement 100 that may be used to roughly predict whether a branch meets the criteria of being in the next cache line. For this logic, it is assumed that cache lines are 128 bytes (or 32 32-bit instructions) in length, and that it is desirable to only prefetch target instructions if the target of a short branch is in the next sequential cache line. Moreover, it is assumed for this logic that a branch instruction 102 is 32 bits in length, with the first six bits (bits 0-5) being the opcode for the instruction, and the last 26 bits (bits 6-31) being the displacement field for the branch. It should be appreciated that branch instructions may also exist that have a shorter displacement field, and it is assumed for this logic that the displacement field has already been extended based upon the type of branch. Yet another assumption is that the instruction being analyzed has already been sufficiently decoded to identify the instruction as a branch instruction with a displacement as opposed to a non-branch instruction or a branch instruction without a displacement.

Generally, circuit arrangement 100 operates by performing an approximation for detecting branches into the next cache line. If the current branch instruction is in one of the first three of four sublines (where each subline is 32 bytes, or eight instructions, in length), it is assumed that a branch instruction can have a target nearly three-quarters of the way into the next cache line and still be a short branch. If in the last subline, it is assumed that the branch instruction can have a target nearly to the end of the next cache line and still be a short branch.

To implement this approximation, three circuit arrangements are used. A first circuit arrangement generates at least one offset signal indicating the offset in the branch instruction displacement field. A second circuit arrangement generates at least one subline signal that indicates the subline of the current branch instruction, and a third circuit arrangement combines the subline and offset signals to output a short branch signal indicating whether the branch instruction is a short branch.

In the illustrated implementation, the first circuit arrangement generates with a series of logic gates 104-144 three signals that indicate whether the displacement for branch instruction 100 is less than 48 instructions (192 bytes), less than 40 instructions (160 bytes) or less than 32 instructions (128 bytes). To generate each of these signals, the 18 most significant bits (MSB's) of the displacement field (bits 6-23 of instruction 1100) are supplied to a plurality of NOR gates 104-120, with NOR gate 104 receiving bits 6 and 7, NOR gate 106 receiving bits 8 and 9, NOR gate 108 receiving bits 10 and 11. NOR gate 110 receiving bits 12 and 13, NOR gate 112 receiving bits 14 and 15, NOR gate 114 receiving bits 16 and 17, NOR gate 116 receiving bits 14 and 19, NOR gate 118 receiving bits 20 and 21, and NOR gate 120 receiving bits 22 and 23.

The outputs of NOR gates 104, 106 and 108 are supplied to an AND gate 122. Similarly, the outputs of NOR gates 110, 112 and 114 are supplied to an AND gate 124, and the outputs of NOR gates 116, 118 and 120 are supplied to an AND gate 126. The outputs of AND gates 122, 124 and 126 are fed to an AND gate 128 that outputs a tgtLt64 signal that is asserted whenever the displacement field for instruction 100 is less than 64 instructions (256 bytes)—which occurs whenever each of bits 6-23 is a logic ‘0’.

A sequence of additional logic gates 130-138 are used to decode bits 24-26 of the instruction. Logic gate 130 is an NAND gate that receives bits 24 and 25. The output of logic gate 130 is then fed to an AND gate 140 along with the tgtLt64 signal output from AND gate 128 to generate a tgtLt48 signal that is asserted if the displacement field for instruction 100 is less than 48 instructions (192 bytes).

Logic gates 132 and 134 are AND gates that respectively receive bits 24 and 25, and bits 24 and 26, of the instruction. The outputs of logic gates 132 and 134 are provided to a NOR gate 136, and the output of NOR gate 136 is fed to an AND gate 142 along with the tgtLt64 signal output from AND gate 128 to generate a tgtLt40 signal that is asserted if the displacement field for instruction 100 is less than 40 instructions (160 bytes).

Logic gate 138 is an inverter gate that receives bit 24 and supplies the inverted value thereof to an AND gate 144. AND gate 144 also receives the tgtLt64 signal output from AND gate 128 to generate a tgtLt32 signal that is asserted if the displacement field for instruction 100 is less than 32 instructions (128 bytes).

For the second circuit arrangement, bits 57 and 58 of a 64-bit program counter (PC), also referred to as an instruction address register, are decoded to determine whether the current instruction is in the first, second, third or fourth subline of the current cache line. The presence of the instruction in the first subline of the current cache line (i.e., in bytes 0-31) is determined by performing a logical-NOR operation on bits 57 and 58 via logic gate 146, resulting in the output of an inSubline0 signal. The presence of the instruction in the second subline of the current cache line (i.e., in bytes 32-63) is determined by performing a logical-AND operation on bit 58 and the inverted value of bit 57 (provided via inverter gate 148) via logic gate 150, resulting in the output of an inSubline1 signal. The presence of the instruction in the third or fourth sublines of the current cache line (i.e., in bytes 64-127) is directly taken from bit 57, resulting in the output of an inSubline2 or 3 signal.

A short branch detected signal, designated shrtBr, is generated in the third circuit arrangement, which includes a sequence of logic gates 152-158. Logic gate 152 is an AND gate that receives the tgtLt48 signal output from logic gate 140 and the inSubline0 signal output from logic gate 146. Logic gate 154 is an AND gate that receives the tgtLt40 signal output from logic gate 142 and the inSubline1 signal output from logic gate 150. Logic gate 156 is an AND gate that receives the tgtLt32 signal output from logic gate 144 and the inSubline2 or 3 signal. The outputs of these gates are then provided to an OR gate 158 to generate the short branch detect signal.

As a result, the short branch detected signal will be asserted: (1) if the instruction is in bytes 0-31 of the current cache line and the target therefor is within 48 instructions (192 bytes) therefrom; (2) if the instruction is in bytes 32-63 of the current cache line and the target therefor is within 40 instructions (160 bytes) therefrom; or (3) if the instruction is in bytes 64-127 of the current cache line and the target therefor is within 32 instructions (128 bytes) therefrom.

It should be appreciated that other circuit arrangements may be utilized to detect a short branch consistent with the invention. For example, more complicated logic may be used to detect up to the end of the next cache line, or exactly 128 bytes forward, etc. However, the use of more complicated logic would necessarily come at the expense of additional circuitry.

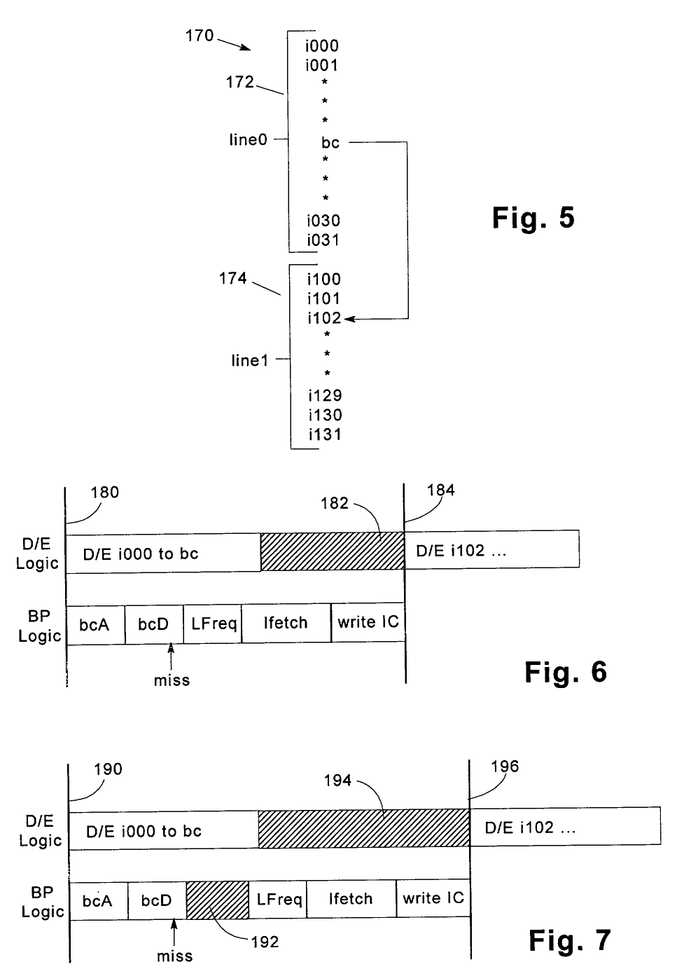

To illustrate the potential performance gains as a result of the illustrated embodiment in processing short branches, FIG. 5 shows an exemplary sequence of instructions 170 stored in a pair of sequential cache lines 172, 174. A sequence of instructions labeled i₀₀₀ to i₀₃₁ is illustrated in cache line 172, and a sequence of instructions labeled i₁₀₀ to i₁₃₁ is illustrated in cache line 174. In addition, within cache line 172 is a branch conditional (bc) instruction that branches to a target address represented by instruction 1102 in cache line 174. As the branch conditional instruction has a target address in the next cache line, the instruction meets the criteria for a short branch.

FIG. 6 illustrates the timing of operations that would occur as a result of processing the sequence of instructions 170 starting at instruction i₀₀₀, assuming that the condition for the branch conditional instruction is met so that the branch is ultimately taken, and that, as of the initial processing of the instructions, instructions i₁₀₀ to i₁₃₁ are not stored in the instruction cache. Starting at the time denoted by line 180, the dispatch/execute (D/E) logic of the system processor results in the sequential processing of instructions beginning with instruction i₀₀₀. Concurrently in the branch prefetch logic, the address of the branch is resolved in the time labeled “bcA” and the directory for the instruction cache is checked to determine whether the target address is currently stored therein. Next, during the time labeled “bcD”, the directory for the instruction cache returns a “hit” or “miss” indication that indicates whether the target address is currently stored in the instruction cache. Moreover, if a “hit” occurs, the data for the target address is concurrently returned. Determination of a cache hit or miss, and the returning of hit data, is typically performed by one or more sequencers in the directory for the instruction cache.

As illustrated by the “miss” arrow in FIG. 6, a predetermined time after the target address for the conditional branch is resolved, the instruction cache directory returns an indication that the target address is not currently in the instruction cache. By virtue of the determination that the branch conditional is a short branch (via circuit arrangement 1100 of FIG. 4, and as represented by block 72 of FIG. 3), a line fill request is immediately issued to the instruction cache to retrieve the next sequential cache line 174 (FIG. 5), represented by the time labeled “LFreq”. A delay then occurs during the time labeled “Ifetch” while the requested cache line is retrieved from memory, and following the delay, the instruction cache is filled, and the requested instructions are bypassed directly to the branch buffer, during the time labeled “write IC”.

It should be noted that, when the branch conditional instruction is encountered by the D/E logic and the branch is taken, a delay will occur while the cache line with the target address is retrieved from memory, represented by delay 182. However, once the instruction cache is filled, and the requested instructions bypassed, processing of the instructions onward starting at target instruction i₁₀₂ may proceed starting at the time represented by line 184.

FIG. 7, in contrast, illustrates the corresponding operation of conventional branch prefetching that does not detect the presence of, nor separately processes, short branches. In this instance, processing of instructions beginning with instruction i₀₀₀ by the D/E logic of the system processor begins at the time represented by line 190, up until the branch conditional instruction is encountered. In the same manner as described above with respect to FIG. 6, concurrently in the branch prefetch logic, the address of the branch is resolved in the time labeled “bcA” and the instruction cache is checked to determine whether the target address is currently stored therein. Next, the indication of a hit or miss in the instruction cache is returned during the time labeled “bcD”. As illustrated by the “miss” arrow in FIG. 6, a predetermined time after the target address for the conditional branch is resolved, the instruction cache returns an indication that the target address is not currently in the instruction cache. However, in the conventional design, no line fill request is issued until the conditional branch is resolved—which will typically occur a short time prior to processing of the branch conditional instruction is performed by the D/E logic. The line fill request is therefore delayed at time represented at 192, which therefore extends the delay (represented by time 194) prior to processing the target instruction i₁₀₂ in the D/E logic at time 196.

As a result, it may be seen that, through detection of and separate handling of short branches, decreased delays, and thus increased performance, typically result due to cache misses for target instructions thereof during branch prefetching.

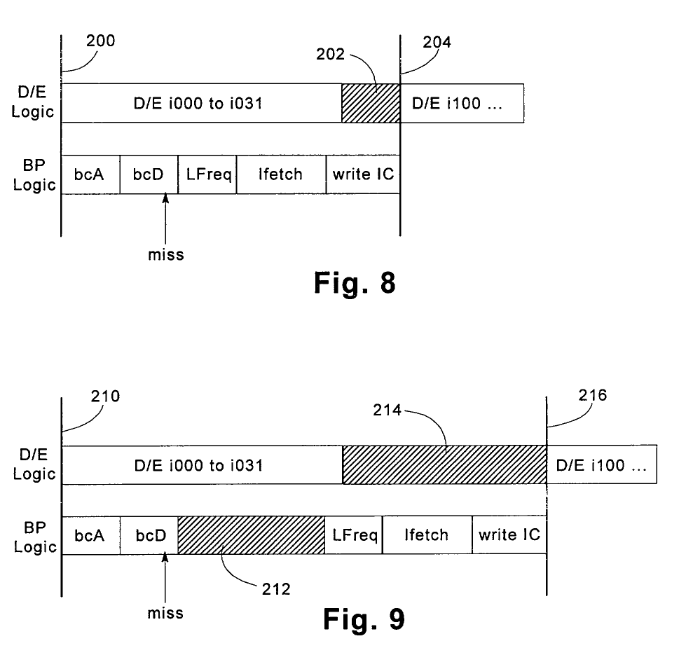

Even when a short branch is not taken, the separate processing thereof consistent with the invention may still provide performance enhancements over conventional designs. For example, FIG. 8 illustrates the timing of operations when the branch conditional instruction in the sequence of instructions of FIG. 5 is not taken. Similar to the timing of FIG. 6, dispatch and execution of the sequence of instructions beginning with instruction i₀₀₀ begins at time 210 and continues through to instruction i₀₃₁ as a result of the conditional branch not being taken. During this time, however, the branch prefetch logic still resolves the target address of the branch conditional instruction and determines whether the instruction is a short branch. Moreover, if the instruction is a short branch, regardless of whether it is taken, a line fill request will be immediately requested and processed by the instruction cache. As a result, the delay from when the last instruction in the current cache line is processed (i₀₃₁) and when the first instruction i₁₀₀ in the next cache line can be processed (at the time represented by line 204) is represented at 202.

In contrast, as shown in FIG. 9, with conventional branch prefetching, detection that a next sequential instruction is not in the instruction cache will not occur until just prior to processing of the last instruction (i₀₃₁) in the current cache line, and thus, the line fill request to retrieve the next cache line will be delayed a time period represented at 212, thereby providing an overall delay represented at 214 until the first instruction in the next cache line (instruction i₁₀₀) can be processed by the D/E logic of the system processor (represented by line 216).

Thus, even when a short branch is not taken, the embodiment described herein can still provide a significant performance improvement over conventional designs.

Various modifications may be made to the illustrated embodiments without departing from the spirit and scope of the invention. For example, a short branch may be defined to incorporate different predetermined portions of the memory address space, e.g., any number of sequential cache lines that follow the cache line within which is located the short branch instruction. Moreover, in addition to the non-predictive embodiments described herein, it should be appreciated that the short branch prefetching consistent with the invention may also be utilized in predictive embodiments, e.g., to retrieve non-predicted sequences of instructions.

Other modifications will become apparent to one of ordinary skill in the art. Therefore, the invention lies in the claims hereinafter appended.

What is claimed is:

1. A method of processing instructions, the method comprising:
(a) fetching a first instruction from a first memory address in a memory address space;
(b) determining whether the first instruction includes a branch to a target memory address in a predetermined portion of the memory address space; and
(c) if the target memory address is in the predetermined portion of the memory address space, fetching a target instruction from the target memory address.

2. The method of claim 1, wherein the predetermined portion of the memory address space is relative to the first memory address.

3. The method of claim 1, wherein the memory address space is partitioned into a plurality of cache lines, wherein the first memory address is located in a first cache line, and wherein determining whether the first instruction includes a branch to a target memory address in the predetermined portion of the memory address space includes determining whether the target memory address is located within a predetermined number of cache lines that sequentially follow the first cache line.

4. The method of claim 3, wherein determining whether the target memory address is located within a predetermined number of cache lines that sequentially follow the first cache line includes determining whether the target memory address is located within a next sequential cache line to the first cache line.

5. The method of claim 4, wherein the first instruction defines an offset between the first memory address and the target memory address, wherein each cache line is partitioned into first, second, third and fourth sublines, and wherein determining whether the target memory address is located within the next sequential cache line includes indicating that the target memory address is located within the next sequential cache line if:
(a) the first memory address is in the first subline of the first cache line and the offset is less than the length of six sublines;
(b) the first memory address is in the second subline of the first cache line and the offset is less than the length of five sublines; or
(c) the first memory address is in the third or fourth sublines of the first cache line and the offset is less than the length of four sublines.

6. The method of claim 5, wherein each cache line is 128 bytes in length, and wherein each subline is 32 bytes in length.

7. The method of claim 1, wherein fetching the target instruction from the target memory address is performed prior to determining whether the branch to the target memory address should be taken, and regardless of whether the target memory address is presently cached in an instruction cache.

8. The method of claim 7, wherein the memory address space is partitioned into a plurality of cache lines, wherein the method further comprises storing at least a portion of the cache lines in the instruction cache, and wherein fetching the target instruction from the target memory address includes retrieving into the instruction cache a cache line associated with the target memory address if the target memory address is not presently cached in the instruction cache.

9. The method of claim 8, wherein filling the instruction cache with the cache line associated with the target memory address includes concurrently filling a branch buffer with at least one instruction from the cache line associated with the target memory address.

10. A method of processing instructions, the method comprising:
(a) fetching a branch instruction from a first memory address in a memory address space; and
(b) fetching a target memory address for the branch instruction prior to determining whether the branch instruction will be taken if the target memory address is cached or if the target memory address is within a predetermined distance from the first memory address.

11. The method of claim 10, wherein the memory address space is partitioned into a plurality of cache lines, wherein the first memory address is located in a first cache line, and wherein the target memory address is within the predetermined distance from the first memory address when the target memory address is within the first cache line or within a next sequential cache line thereto.

12. A circuit arrangement, comprising:
(a) a cache configured to store a plurality of instructions that are addressed at selected memory addresses in a memory address space; and
(b) an instruction unit, coupled to the cache, the instruction unit configured to dispatch selected instructions from the cache to an execution unit for execution thereby, the instruction unit further configured to fetch a target instruction referenced by a branch instruction prior to determining whether a branch therefor will be taken, and regardless of whether the target instruction is stored in the cache, if the target instruction is addressed at a target memory address within a predetermined portion of the memory address space.

13. The circuit arrangement of claim 12, wherein the memory address space is partitioned into a plurality of cache lines, and wherein the instruction unit includes a short branch detector configured to determine whether the target memory address is within the predetermined portion of the memory address space by determining whether the target memory address is located within a predetermined number of cache lines that sequentially follow a cache line within which is stored the branch instruction.

14. The circuit arrangement of claim 13, wherein the predetermined number of cache lines is one.

15. The circuit arrangement of claim 14, wherein each cache line is partitioned into a plurality of sublines, and wherein the short branch detector includes:
(b) a first circuit arrangement configured to output at least one offset signal indicating an offset between the target memory address and a memory address at which the branch instruction is addressed;
(b) a second circuit arrangement configured to output at least one subline signal that indicates the subline within which is stored the branch instruction; and
(c) a third circuit arrangement configured to receive the offset and subline signals from the first and second circuit arrangement and output therefrom a short branch signal representative of whether the target memory address is located within the next sequential cache line to that within which is stored the branch instruction.

16. The circuit arrangement of claim 15, wherein the first circuit arrangement is configured to output multiple offset signals indicating whether the offset is within different numbers of sublines.

17. The circuit arrangement of claim 15, wherein each cache line is 128 bytes in length, and wherein each subline is 32 bytes in length.

18. The circuit arrangement of claim 12, wherein the memory address space is partitioned into a plurality of cache lines, wherein the cache is configured to store the instructions from at least a portion of the cache lines in the memory address space, and wherein the instruction unit is further configured to, when fetching the target instruction referenced by the branch instruction, request that the cache line associated with the target memory address be retrieved into the cache if the cache line associated with the target memory address is not presently cached in the cache.

19. The circuit arrangement of claim 18, wherein the instruction unit further includes a branch buffer and a cache bypass circuit arrangement coupled thereto, the cache bypass circuit arrangement configured to fill the branch buffer with at least one instruction from the cache line associated with the target memory address concurrently with retrieval of the cache line associated with the target memory address into the cache.

20. The circuit arrangement of claim 12, wherein the instruction unit is further configured to fetch a second target instruction referenced by a second branch instruction only after determining whether a branch therefor will be taken, if the second target instruction is addressed at a second target memory address within a second predetermined portion of the memory address space and the second target instruction is not stored in the cache.

21. The circuit arrangement of claim 20, wherein the memory address space is partitioned into a plurality of cache lines, wherein the cache is configured to store the instructions from at least a portion of the cache lines in the memory address space, and wherein the instruction unit is configured to defer fetching the second target instruction referenced by the second branch instruction until after determining whether the branch therefor will be taken if the second target instruction is addressed beyond a predetermined number of cache lines from a cache line associated with the branch instruction and the cache line associated with the target memory address is not presently cached in the cache.

22. The circuit arrangement of claim 12, wherein the cache is an instruction cache.

23. An integrated circuit device comprising the circuit arrangement of claim 12.

24. A data processing system comprising the circuit arrangement of claim 12.

25. A program product, comprising:
(a) a hardware definition program that defines the circuit arrangement of claim 12; and
(b) a signal bearing media bearing the hardware definition program.

26. The program product of claim 25, wherein the signal bearing media is transmission type media.

27. The program product of claim 25, wherein the signal bearing media is recordable media.

28. A data processing system, comprising:
(a) a memory defining a memory address space and including a plurality of memory addresses; and
(b) an integrated circuit device coupled to the memory, the integrated circuit device including:
(1) a cache coupled to the memory and configured to store a plurality of instructions that are addressed at selected memory addresses in the memory address space; and
(2) an instruction unit coupled to the cache, the instruction unit configured to dispatch selected instructions from the cache to an execution unit for execution thereby, the instruction unit further configured to fetch a target instruction referenced by a branch instruction prior to determining whether a branch therefor will be taken, regardless of whether the target instruction is stored in the cache, and if the target instruction is addressed at a target memory address within a predetermined portion of the memory address space.
